(19) United States
(12) Patent Application Publication
(10) Pub. No.: US 2007/0008503 A1
(43) Pub. Date: Jan. 11, 2007

(54) Dual image projection system

(76) Inventor: Hae-Yong Choi, Seoul-City (KR)

Correspondence Address: BACON & THOMAS, PLLC, 625 SLATERS LANE, FOURTH FLOOR, ALEXANDRIA, VA, 22314, US

(21) Appl. No.: 11/411,115

(22) Filed: Apr. 26, 2006

(30) Foreign Application Priority Data
Jul. 11, 2005 (KR) 10-2005-0063076

(51) Int. Cl. G03B 21/28

(52) U.S. Cl. 353/98

(57) ABSTRACT

A dual image projection system separates a single image projected from a single projector into two images vertically or horizontally, inputs the separated images by reversing the left and right sides of the separated images, and completely separates the separated images using a separation mirror disposed in front of a projection lens of the projector such that the separated images are displayed on left and right screens or on front and rear screens. The images displayed on the screens are normal images whose right and left sides are not reversed.

### BACKGROUND OF THE INVENTION

1. Field of the Invention

The present invention relates to an image projection system for editing a single image into dual images and inputting the dual images into a single projector to project the dual images, in particularly, to a high definition dual image projection system in which images are formed on a front screen and a rear screen (or on an upper screen and a lower screen) such that a viewer can watch the images in front of and at the rear side of the screen, or a left screen and a right screen are provided on a left slope and a right slope of a triangular screen such that an image projection system with a wide viewing angle, and utilized as an advertising device whose screens are horizontally arranged on which dual images made of a single image are formed.

In particular, the present invention relates to a dual image projection system in which a single image of a projector is made into multiple normal images more than two images such that the multiple front and rear images or multiple left and right images whose right and left sides are not reversed in relation to the viewing position of a viewer so that the viewer can watch the images as normal images.

Moreover, the present invention relates to a solid image projection system in which a single image of a projection is made into dual images, a right image and a left image, which are symmetrically reflected and combined to display a solid image, instead a conventional solid image projection system that can be implemented by only two projectors.

2. Description of the Related Art

According to a conventional projection system, when two more images are displayed on two more screens, that is, front and rear screens or right and left screens, there are required as many projectors as the number of screens. In this case, as the number of the projectors is increased, the volume of the entire image projection system is also increased. Thus, a device for removing heat from light sources of the projectors is complicated. In particular, when the conventional image projection system is utilized as an advertising apparatus, costs for use of the expensive multiple projectors is high, and as the number of the projectors is increased, costs for exchange of lamps of the projectors as consumable items are also increased.

Further, as shown in FIG. 1, according to a both-side screen (International Patent Application No. PCT/KR2003/002172) filed by this applicant of this patent application, a single image of a projector is transformed into dual images in a single screen such that viewers can watch the dual images formed on a front side a rear side of the screen. However, according to the both-sided screen, the images formed on a front screen 4c and a rear screen 4d of the screen have reversed right and left sides.

Since a conventional triangular image projection system displays images in diagonal directions from viewer's positions, the conventional triangular image projection system has a wide viewing angle. However, projectors corresponding to the right and the left screens of the triangular image projection system must be provided. Moreover, since the conventional triangular image projection system having the both-sided screen has a problem of reflecting the image by a single sided mirror, the viewing angle of the image reflected by the mirror becomes narrow and has a difficulty for the utility thereof.

Since a conventional bar-shaped advertising apparatus, as shown in FIG. 9a, uses an LED 10a and has a low resolution so that an image such as a motion picture is displayed in mosaic form, the conventional bar-shaped advertising apparatus cannot display the motion picture such as a movie but displays mainly characters and figures. Thus, it is difficult to achieve a great advertising effect from the conventional bar-shaped advertising apparatus.

### SUMMARY OF THE INVENTION

Therefore, the present invention has been made in view of the above and/or other problems, and it is an object of the present invention to provide a dual image projection system in which a single image of a projector is made into two more upper and lower or right and left images in front of a projection lens of the projector, the dual images are reflected by reflection mirrors in predetermined respective directions to be projected on right and left screens, wherein the images formed on the right and the left screens are normally displayed as normal images whose left and right sides are not reversed and the dual image projection system can be utilized in various image projection systems.

It is other object of the present invention to provide a dual image projection system for making a single image of a projector into front and rear images (or left and right images) such that the front and the rear images are projected as normal images, in which characters and motion pictures right and left sides are not reversed.

It is another object of the present invention to provide a dual image projection system for projecting a single image of a projector on left and right slopes of a triangular structure such that left and right images formed on the left and the right sides of the triangular structure are normally displayed without distortion.

It is still another object of the present invention to provide a dual image projection system for a single image of a projector into dual images in the form of a bar such that the dual images are displayed as- normal images without distortion and form a single bar-shape.

It is still another object of the present invention to provide a dual image projection system for making a single image of a projector into a left image and a right image and for editing the left image and the right image such that the left image and the right image are deflected by polarizing plates and are combined with each other to display a solid image using only a single projector.

### BRIEF DESCRIPTION OF THE DRAWINGS

These and/or other aspects and advantages of the present invention will be come apparent and more readily appreciated from the following description of the embodiments, taken in conjunction with the accompanying drawings, in which:

FIG. 1 is a view illustrating a conventional both-sided screen;

FIG. 2 is a view illustrating a basic structure of a dual image projection system according to a preferred embodiment of the present invention;

FIG. 2a is a view illustrating images edited by the dual image projection system according to the preferred embodiment of the present invention;

FIG. 3 is a view illustrating an image separation mirror utilized in the dual image projection system according to the preferred embodiment of the present invention;

FIG. 3a is a view illustrating a prism-shaped image separation mirror utilized in the dual image projection system according to the preferred embodiment of the present invention;

FIG. 3b is a view illustrating a pyramid-shaped image separation mirror utilized in the dual image projection system according to the preferred embodiment of the present invention;

FIG. 3c is a view illustrating operation of the pyramid-shaped image separation mirror in FIG. 3b;

FIG. 4 is a view illustrating a dual image projection system according to a first preferred embodiment of the present invention in which dual screens are disposed at the front side and at the rear side thereof;

FIG. 4a is a perspective view illustrating the dual image projection system in FIG. 4;

FIG. 5 is a view illustrating a triangular dual image projection system according to a second preferred embodiment of the present invention;

FIG. 5a is a perspective view of the triangular dual image projection system in FIG. 5;

FIG. 6 is a view illustrating the dual image projection system in FIG. 5 installed on a street-side wall;

FIG. 7 is a view illustrating the dual image projection system according to the preferred embodiment of the present invention coupled with a desk;

FIG. 8 is a view illustrating a bar-shaped dual image projection system according to a third preferred embodiment of the present invention;

FIG. 9 is a view illustrating an application of the bar-shaped dual image projection system in FIG. 8;

FIG. 9a is a view illustrating a conventional light emitting diode advertising display;

FIG. 10 is a view illustrating a dual image projection system according to a fourth preferred embodiment of the present invention;

FIG. 11 is a view illustrating a dual image projection system according to a fifth preferred embodiment of the present invention;

FIG. 12 is a view illustrating a dual image projection system according to a sixth preferred embodiment of the present invention;

FIG. 13a is a view illustrating a conventional front and rear both-sided screen;

FIG. 13b is a view illustrating effect of the dual image projection system according to the first preferred embodiment of the present invention;

FIG. 14a is a view illustrating a conventional triangular image projection system;

FIG. 14b is a view illustrating effect of the dual image projection system according to the second preferred embodiment of the present invention;

FIG. 15a is a view illustrating a conventional bar-shaped advertising display;

FIG. 15b is a view illustrating effect of the dual image projection system according to the third preferred embodiment of the present invention;

FIG. 16a is a view illustrating a conventional solid image projector; and

FIG. 16b is a view illustrating effect of the dual image projection system according to the sixth preferred embodiment of the present invention.

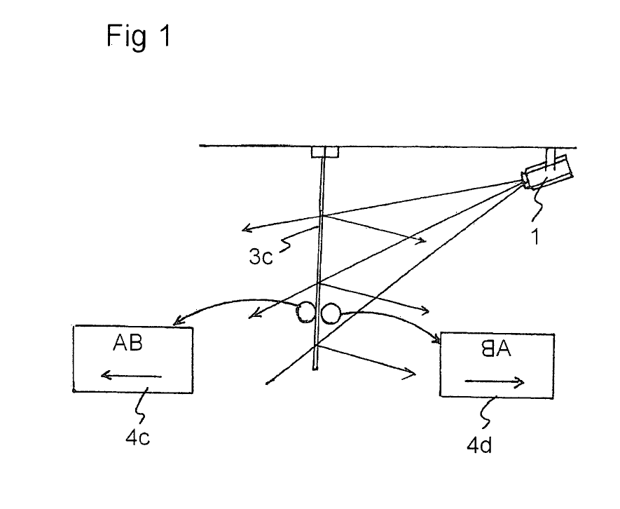

### DESCRIPTION OF THE PREFERRED EMBODIMENTS

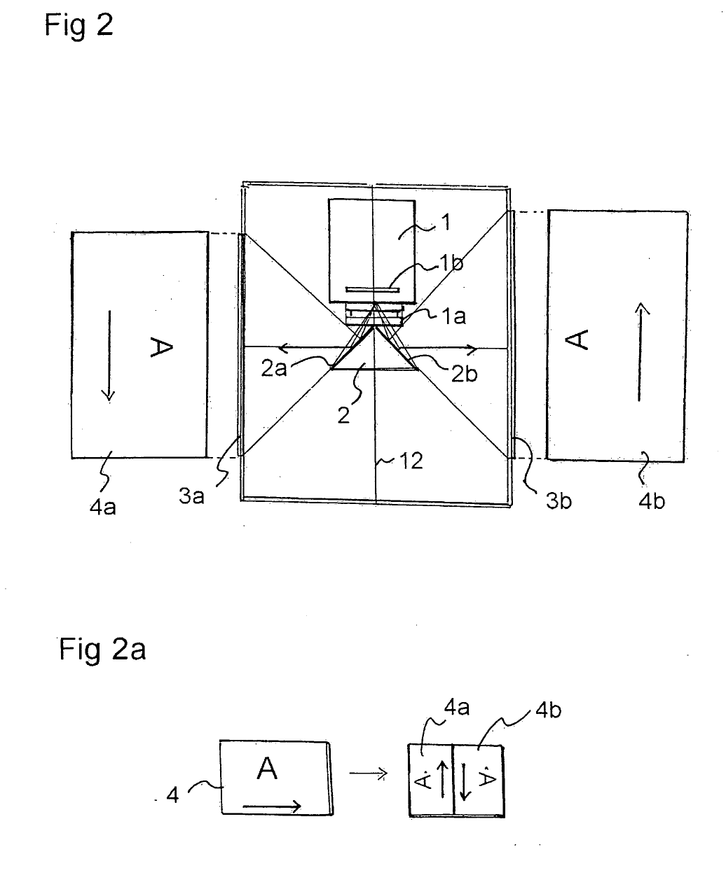

An image of a projector, as shown in FIG. 2a, can be edited by a conventional image editor such that an original image 4 can be split into identical upper and lower images or left and right images, or images whose upper and lower side or left and right sides are reversed, or completely different images, as a left image 4a and a right image 4b to be displayed on a single screen.

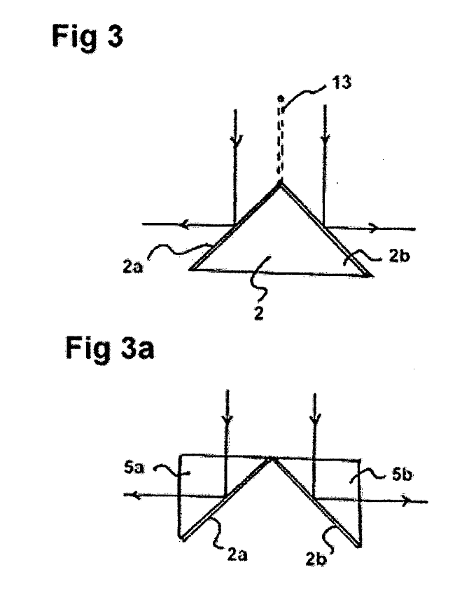

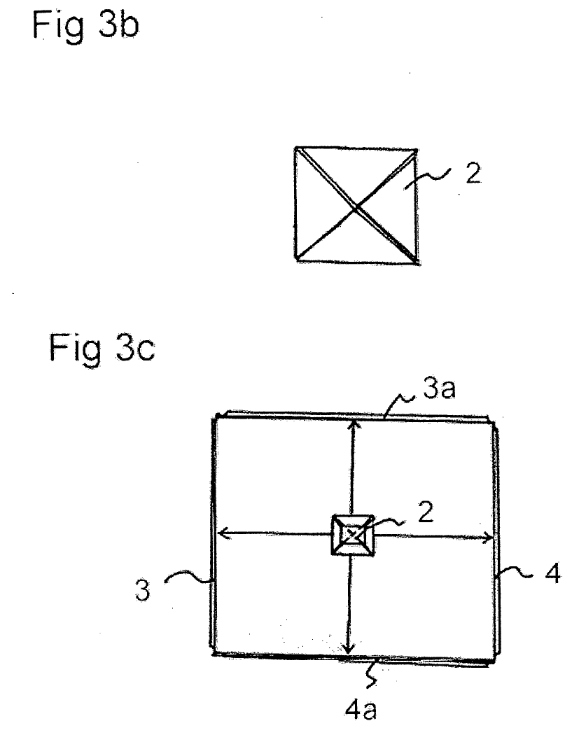

A dual image projection system according to a preferred embodiment of the present invention inputs such split and edited images into a single projector, and displays images projected by a separation mirror 2 for separating the edited images, as shown in FIGS. 3 and 3a, on a left screen 3a and a right screen 3b.

In other words, as shown in FIG. 2, the separation mirror 2 is installed in front of a projection lens 1a of the projector 1. The separation mirror 2 has a vertex angle part having a predetermined vertex angle and a left reflection surface 2a and a right reflection surface 2b respectively formed at the left slope and the right slope of the vertex angle part. The separation mirror 2 is installed in front of the projection lens 1a of the projector such that the vertex angle part where the left slope 2a meets the right slope 2b is positioned on the central axis 12 of the projection lens 1a so that the images projected from the projection lens 1a are separated into two images such as the upper and lower or left and the right images.

As shown in FIG. 3, the separation mirror 2 may be structured such that two reflection mirrors are symmetrically at an inclined angle according to a required projection angle.

In other words, as shown in FIG. 3, the separation mirror 2 may be structured such that the left reflection surface 2a and the right reflection surface 2b are made of reflection mirrors, or are formed on both slopes of a prism, or a blocking layer 13 is formed at the central portion of the vertex angle part of the left reflection surface 2a and the right reflection surface 2b.

Moreover, as shown in FIG. 3a, the separation mirror 2 may be substituted with a reflection prism including a left prism 5a and a right prism 5b symmetrically formed on the left reflection surface 2a and the right reflection surface 2b.

As shown in FIG. 3b, when the separation mirror 2 is formed in the form of a pyramid, a single image of a projector 1, as shown in FIG. 3c, can be projected on four directional screens 3, 3a, 4, and 4a formed in four directions of a front direction, a backward direction, a left direction, and a right direction.

A left screen 3a and a right screen 3b are installed in front of the separation mirror 2 where the images are separately projected according to the reflection directions of the separation mirror 2, and if necessary, although not depicted in FIG. 2, a left reflection mirror 9a and a right reflection mirror 9b may be added and will be described in detail later.

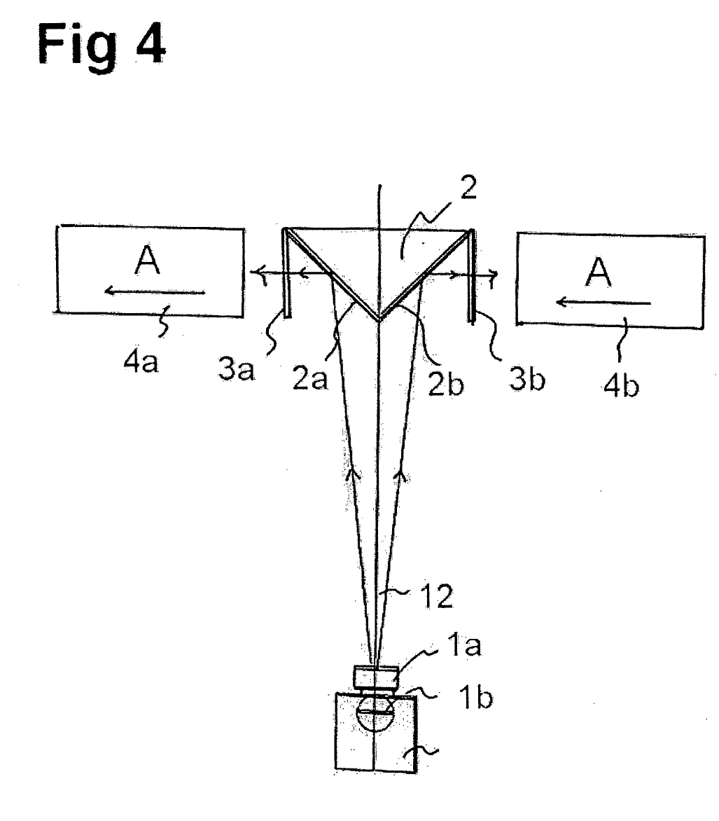

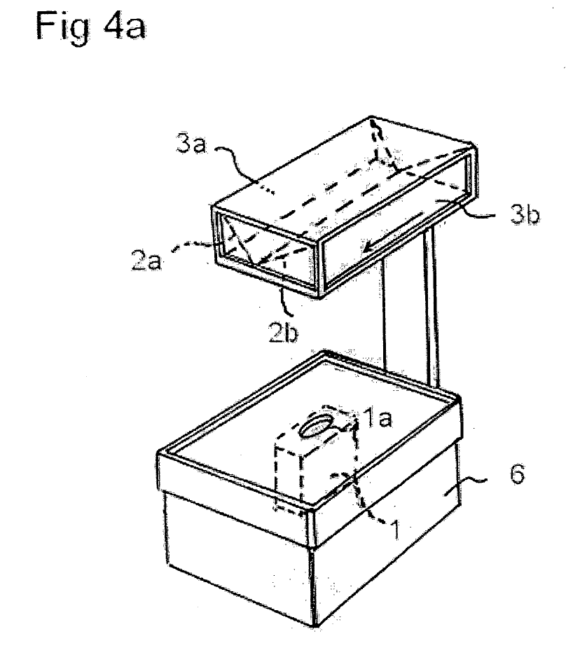

A dual image projection system according to a first preferred embodiment of the present invention, as shown in FIG. 4, is a system in which images projected from a single projector 1 can be viewed through the left screen 3a and the right screen 3b (or a front screen and a rear screen).

As shown in FIG. 4, the images of the projector 1 projected from the lower side of the separation mirror 2 are separated by the separation mirror 2 disposed at the upper side on the central axis 12 of the projection lens la and projected on the left screen 3a and the right screen 3b, respectively.

The above left screen 3a and right screen 3b are identical to the front screen and the rear screen.

In the above structure, the positions of the screens are identical to a reversed structure in which the projector 1 projects the images from an upper side to a lower side.

The images, as shown in FIG. 2a, edited by an image editor, as shown in FIGS. 2 and 4, are displayed such that the left image 4a is reflected by the left reflection surface 2a of the separation mirror 2 disposed on the central axis 12 of the projection lens 1a and is displayed on the left screen 3a as a normal image without distortion, and in the same principle as the left image, the right image 4b is reflected by the right reflection surface 2b and is displayed on the right screen 3b as a normal image without distortion.

The dual image projection system according to the first preferred embodiment of the present invention, as shown in FIG. 4a, can be applied to an article display table 6 such that the articles are displayed as well as motion pictures, related to the displayed articles, are displayed on two screens, a front screen and a rear screen or a left screen and a right screen, using a single projector to advertise the articles.

The dual image projection system according to the first preferred embodiment of the present invention can be applied to various apparatus such as an advertising apparatus, an advertisement imaging apparatus, and the like.

A dual image projection system according to a second preferred embodiment of the present invention includes a single projector 1, and a left screen 3a and a right screen 3b formed on slopes of a triangular frame 7.

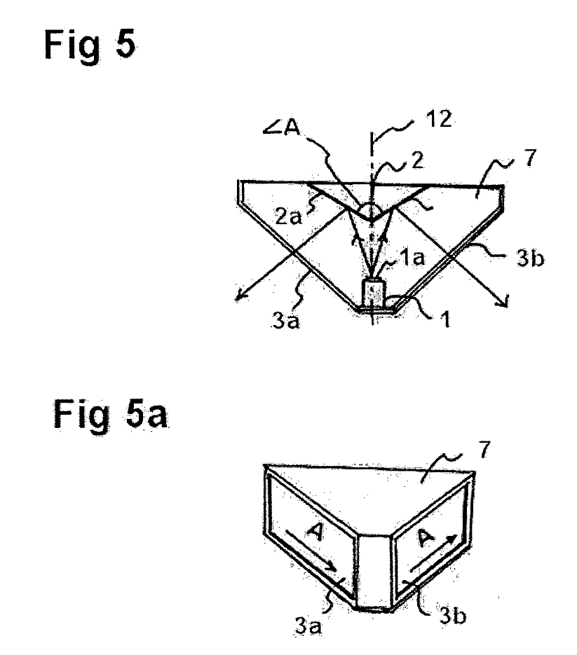

As shown in FIG. 5, the projector 1 is installed at a rear central side of the triangular frame 7 and the separation mirror 2 is installed on a central axis 12 of the projection lens 1a disposed in front of the projector 1.

An angle ∠A formed by a left reflection surface 2a and a right reflection surface 2b is greater than 90 degrees, preferably 100 degrees to 120 degrees, and is determined as an angle proper for images, projected on the left screen 3a and the right screen 3b, to be formed.

As described above, the dual image projection system according to the second preferred embodiment of the present invention as shown in FIG. 5 is installed at street, a passageway of a department, a street-side wall of a shop as shown in FIG. 6, or on the ceiling as shown in FIG. 6a to effectively display advertising image to people passing from either direction.

The dual image projection system in FIG. 5, as shown in FIG. 6a, may be utilized as an advertising system installed on the ceiling of a space such as a subway or a train.

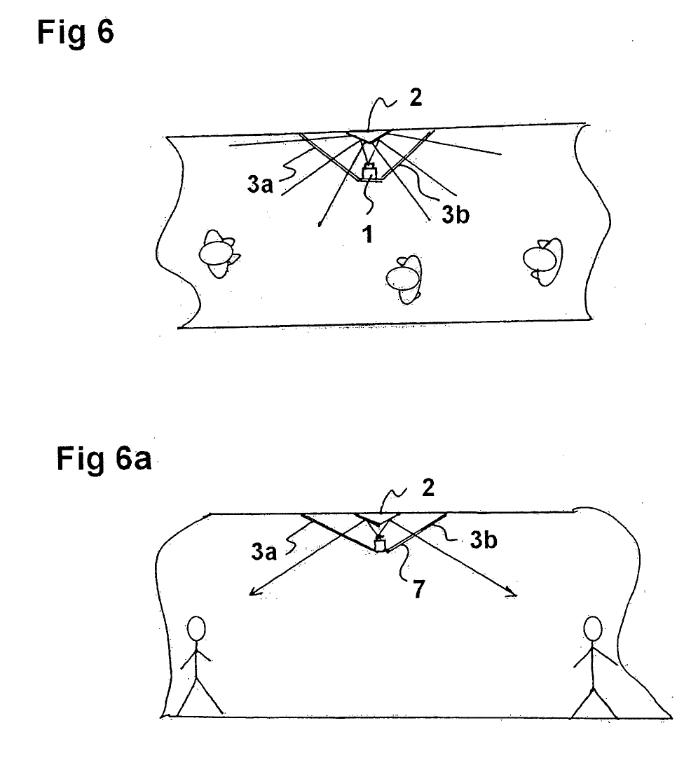

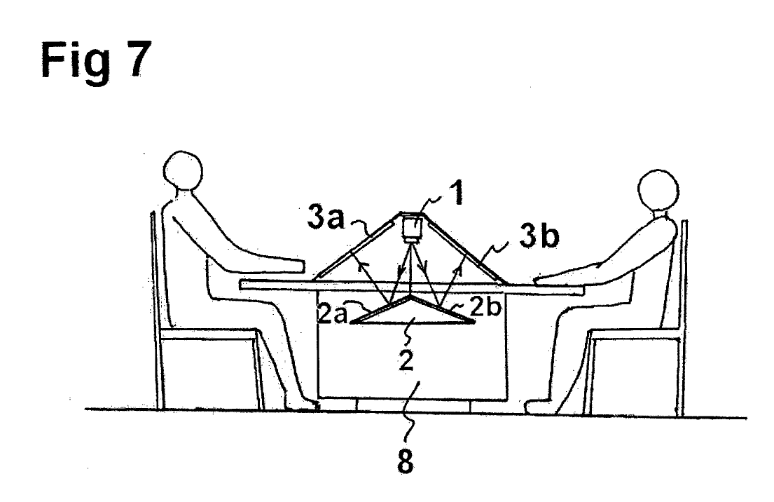

Moreover, as shown in FIG. 7, when the dual image projection system is installed on a table 8 such as a desk, since viewers in front of and behind the dual image projection system can watch simultaneously, the dual image projection is effectively utilized as an image desk for guiding civil petitions or an electronic game apparatus which two gamers can play.

In other words, the dual image projection system according to the second preferred embodiment of the present invention is installed on the desk 8 so that customers seated at the left and right sides of the desk 8 can watch an identical image or different images simultaneously.

A dual image projection system according to a third preferred embodiment of the present invention is structured as a long advertising system having a ratio of width:length of 2.5:1-7:1.

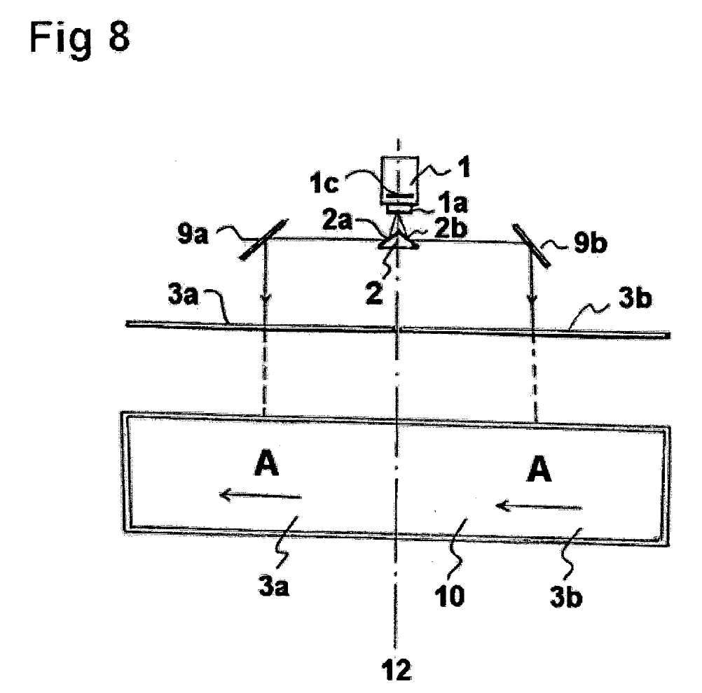

As shown in FIG. 8, in the dual image projection system according to the third preferred embodiment of the present invention, images edited and separated into an upper image and a lower image are inputted into the projector 1, the separated images are separated to the left side and the right side by the separation mirror 2 disposed on the central axis 12 of the projection lens 1a and are reflected by the left reflection mirror 9a and a right reflection mirror 9b, and the reflected images are projected on the left screen 3a and the right screen 3b which are arranged in series.

Generally, the aspect ratio of a video screen is 16:9 or 4:3.

The dual image projection system in FIG. 4 according to the first preferred embodiment of the present invention is utilized as a window advertising system of a shop. Since such the window advertising system with the aspect ratio of 4:3 or 16:9 obstructs the shop window, it is not suitable as the window advertising system.

An image with an aspect ratio 16:9 is separated into an upper image and a lower image with aspect ratios of 16:4.5, and when the separated images are horizontally combined, the combined image becomes a very-long bar-shaped image with an aspect ratio of 32:4.5 or about 7:1.

An image with an aspect ratio of 4:3 is vertically separated into two images, that is, images with aspect ratios of 4:1.5, and when the separated images are combined with each other, the combined image becomes an image with an aspect ratio of 8:1.5.

In other words, the dual image projection system of the present invention, as shown in FIG. 4, separates an image with an aspect ratio of 16:9 or 4:3 vertically and arranges the separated images horizontally so that a long image with a minimum aspect ration of 2.25:1 to maximum aspect ratio of 7:1 can be displayed without deterioration of resolution of the image and obstructing the shop window.

In the dual image projection system, since an image of the projector 1 is vertically separated and the separated images are projected and enlarged to be horizontally arranged, there may be a phase difference between the images.

This problem can be solved by adjusting upper and lower reflection angles of the left reflection mirror 9a and the right reflection mirror 9b to be symmetric and by partially overlapping the overlapped portion of the images using a conventional overlay technology when editing the images using an image editor.

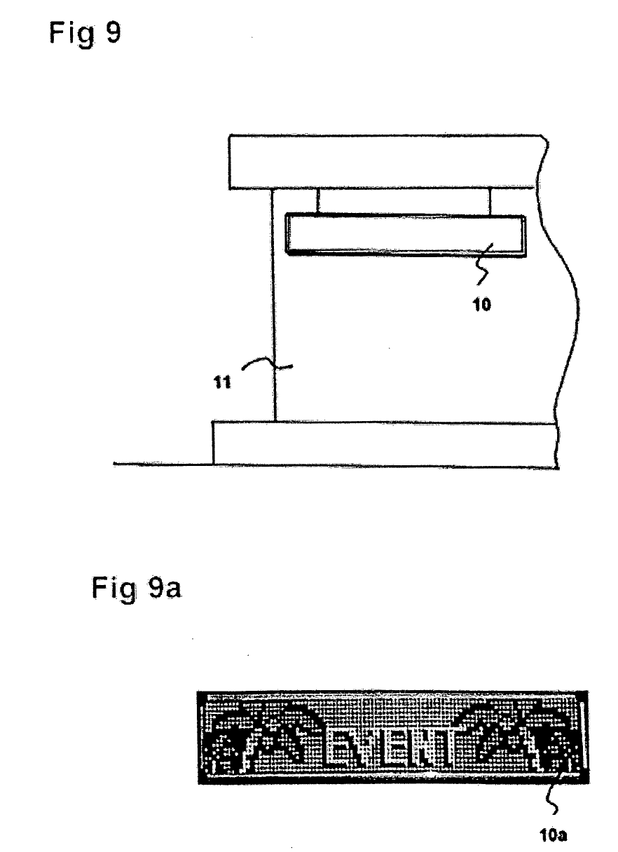

Moreover, the window advertising system, as shown in FIG. 9a, is an image system mainly structured by light emitting diodes (LED) 10a and is able to display characters but displays the image as a mosaic because of a very low resolution due to the size of the LEDs 10a. Thus, the window advertising system cannot be used as a system for displaying a high quality motion picture.

In other words, the resolution of the conventional LED window advertising system is generally lower than 100 thousand pixels. However, since the resolution of the dual image projection system using a projector of an XGA level is greater than about 2500 thousand pixels, a high resolution greater than 625 times that of the conventional LED window advertising system, a square of 25 times, can be achieved.

The dual image projection system as shown in FIG. 8 according to the preferred embodiment of the present invention can be effectively utilized an advertising system or a motion picture displaying apparatus installed on a wall of a building, inside or outside a shop to display the motion picture, as shown in FIG. 9.

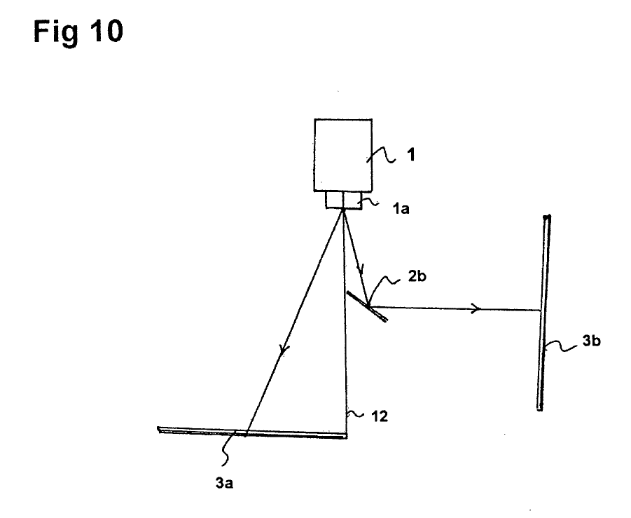

In a dual image projection system according to a fourth preferred embodiment of the present invention, as shown in FIG. 10, the separation mirror 2 is installed such that the right reflection mirror 2b is installed to reflect light to one side of the central axis 12 of the projection lens 1a. Thus, only a half of the projected image is reflected and the rest is projected as it is.

In a dual image projection system according to a fifth preferred embodiment of the present invention, as shown in FIG. 11, the projector 1 is installed on the central region of the ceiling of a passageway and the left screen 3a and the right screen 3b are installed on sidewalls of the passageway.

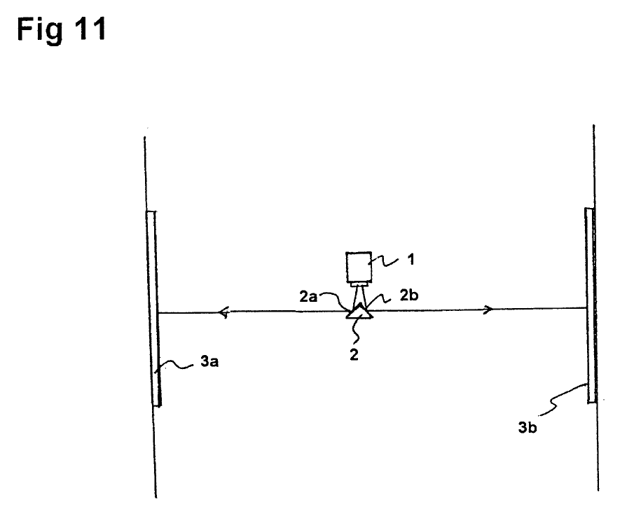

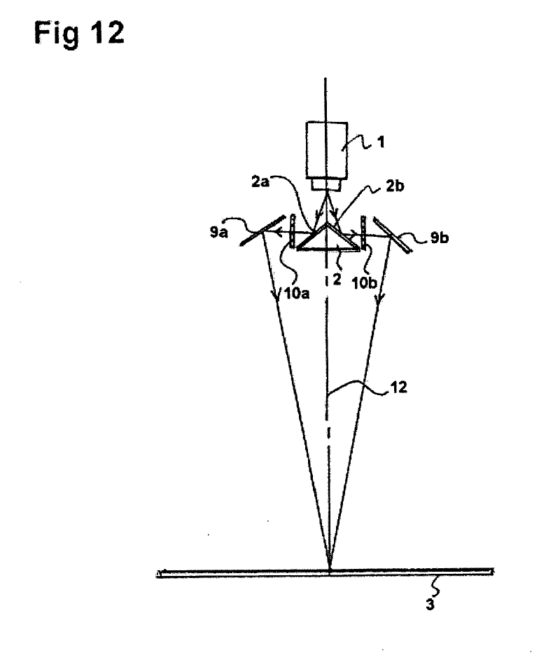

In a dual image projection system according to a sixth preferred embodiment of the present invention, as shown in FIG. 12, two images, a left image and a right image projected from a single projector 1 are separated and projected by the separation mirror 2 installed on the central axis 12 of the projection lens la, are symmetrically deflected in the horizontal direction by respective polarization filters 10a and 10b, and the deflected images are combined with each other on the screen 3. By doing so, a solid image, that the conventional image projection system projects using two projectors is formed by the dual image projection system of the present invention using a single projector 1.

In other words, as shown in FIG. 12, in the dual image projection system according to the sixth preferred embodiment of the present invention, the single projector 1 separates an image into a left image and a right image to project the left image left and the right image right, the separation mirror 2 reflects the left image and the right image left and right respectively, symmetrical polarization plates 10a and 10b are installed in front of the separation mirror 2, and the reflection angles of the left reflection mirror 9a and the right reflection mirror 9b are adjusted to combine the left image and the right image reflected by the left reflection mirror 9a and the right reflection mirror 9b on a single screen 3.

In the conventional solid image projection system, since the left image and the right image are respectively inputted into two projectors and the projected images must be combined with each other on the screen, a device for synchronizing the images and the two projectors is required. However, in the dual image projection system according to the sixth preferred embodiment of the present invention, since a single projector is used and the single projector projects the left image and the right image simultaneously, the solid image can be obtained without the synchronizing device.

Moreover, although the left screen 3a and the right screen 3b of all the dual image projection systems of the present invention are preferably transparent screens, the screens can be substituted with front type screens if required.

Generally, the projector used in the advertisement image system such as the dual image projection system of the present invention has a luminosity of 5000, an average weight of 5 kg to 10 kg, and a length of 40 cm to 50 cm.

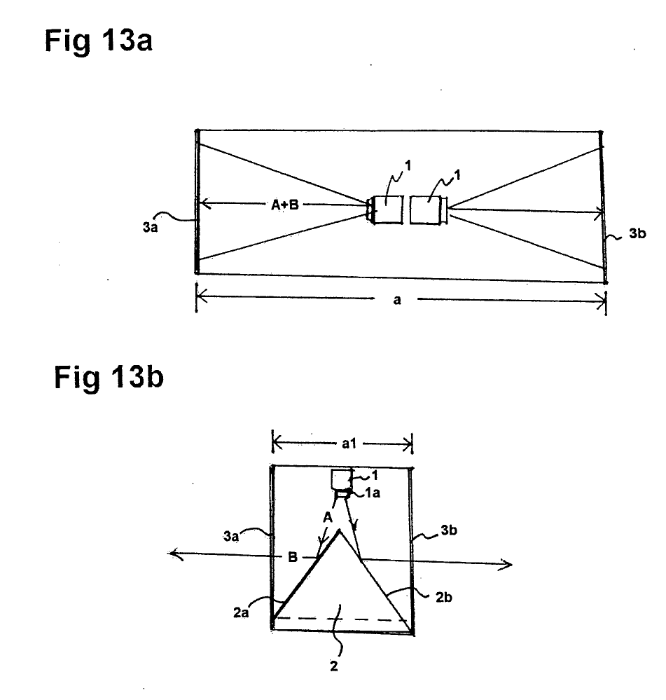

The size of the screen is determined by the projection distance of the projector. As standard, the shortest projection distance of the projector is 1 m unless using a specific projection lens. In other words, within the projection distance A+B=1 m (See FIG. 13a), since the images projected through the projection lens of the projector is not formed clearly on the screen, the images cannot be watched.

As shown in FIG. 13a, in the conventional image projection system in which the screens are arranged at the left side and the right side or at the front side and the rear side of the system, in a case of installing the screens 3a and 3b at the left side and the right side of the conventional image projection system and installing the projectors 1 at the central region of the conventional image projection system by spacing the projectors 1 apart as far as the projection distance, the projection distances A+B of the projector 1 are formed in the left side and the right side of the dual image projection system, the total length a of the conventional image projection system must be greater than 1 m+1 m=2 m, and the weight of the system is 20 kg because there are two projectors.

On the contrary, in the dual image projection system according to the first preferred embodiment of the present invention as shown in FIG. 13b, since there is one projector and the projection distance A+B is separated by the separation mirror 2, the total length of the dual image projection system of the present invention is 0.5 m, thus it can be reduced by 50% of that of the conventional image projection system and the weight can be also reduced.

As such, since volume, weight, and costs of the dual image projection system of the present invention can be remarkably reduced, the dual image projection system of the present invention can be utilized in various fields.

In other words, like the dual image projection system according to the first preferred embodiment of the present invention, the images are projected onto the left screen 3a and the right screen 3b (or the front screen and the rear screen) using the separation mirror 2 so that the dual image projection system of the present invention can be utilized as an article displaying table 6, or various advertising systems such as an image advertising system in which normal images can be watched in front of and behind the system.

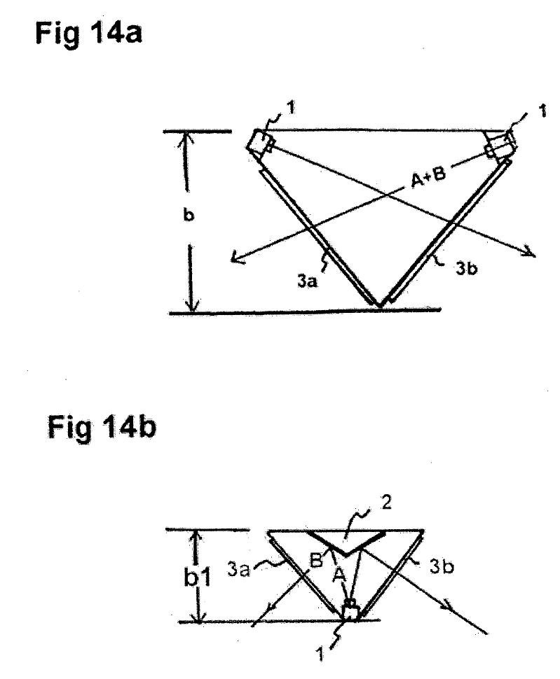

As shown in FIG. 14a, since in the conventional triangular image system the projectors 1 are installed at the rear left corner and the rear right corner and the screens are disposed on the slopes at positions spaced apart by the shortest projection distances of the projectors 1, the conventional triangular image system has a big volume and is heavy due to the two projectors 1. The conventional triangular image system using projectors cannot be installed on a wall and the ceiling because of volume and weight.

On the contrary, in the dual image projection system of the present invention, as shown in FIG. 14b, since a single projector 1 is installed at the central corner of the triangular frame and the projection distance A+B is separated by the separation mirror 2, in comparison to the conventional triangular image system in FIG. 14a, the volume of the dual image projection system of the present invention can be reduced by more than a half, the weight thereof is reduced to a half or more, and the weight of the triangular frame 7 can also be reduced by more than a half.

Thus, since the dual image projection system of the present invention can be utilized in various places for various uses, the dual image projection system of the present invention can be used as an advertising system installed on the ceiling or a wall. Moreover, since the dual image projection system of the present invention can be installed on a desk, the dual image projection system can be used as a guide desk and a game device for two persons.

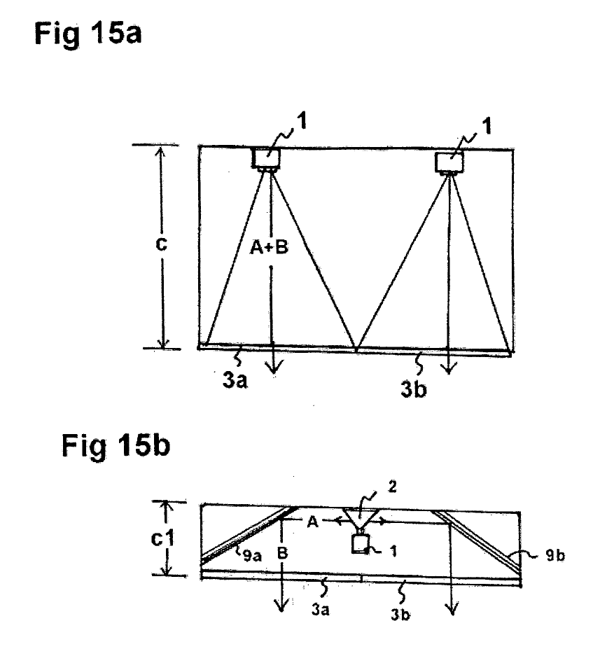

As shown in FIG. 15a, for a horizontally long bar-shaped advertising system, generally, the length of the screen is shorter than the projection distance A+B of the projector 1, so that the volume of the horizontally long bar-shaped advertising system is relatively increased.

Moreover, when two screens are arranged horizontally in series, as shown in FIG. 15a, the volume of the bar-shaped advertising system is too big. Thus, it is essentially impossible to install the bar-shaped advertising system at the window of a shop and therefore it cannot be put to practical use.

On the contrary, for the dual image projection system in FIG. 15b, a single image from the single projector 1 is separated into the left and right images and the separated images are reflected by the left and right reflection mirrors 9a and 9b, so that the volume and the weight thereof are remarkably reduced in comparison to the conventional system.

The reduction of the volume and the weight of the dual image projection system enables the installation of the dual image projection system at the shop window so that the dual image projection system of the present invention can be put to practical use as an advertising system.

Thus, in the dual image projection system according to the third preferred embodiment of the present invention, since the image with an aspect ratio of 16:9 or 4:3 is separated into two images vertically and the separated images are arranged horizontally, the dual image projection system of the present invention can be used as the bar-shaped advertising system having an aspect ratio of minimum 2.5:1 to maximum 7:1. The dual image projection system can be utilized as an advertising system and an image system for displaying a motion picture of various types, such as a news program. In particular, although the conventional LED advertising system has a low resolution causing problems to display a motion picture such as a movie, the high-resolution bar-shaped dual image projection system of the present invention can display the motion picture.

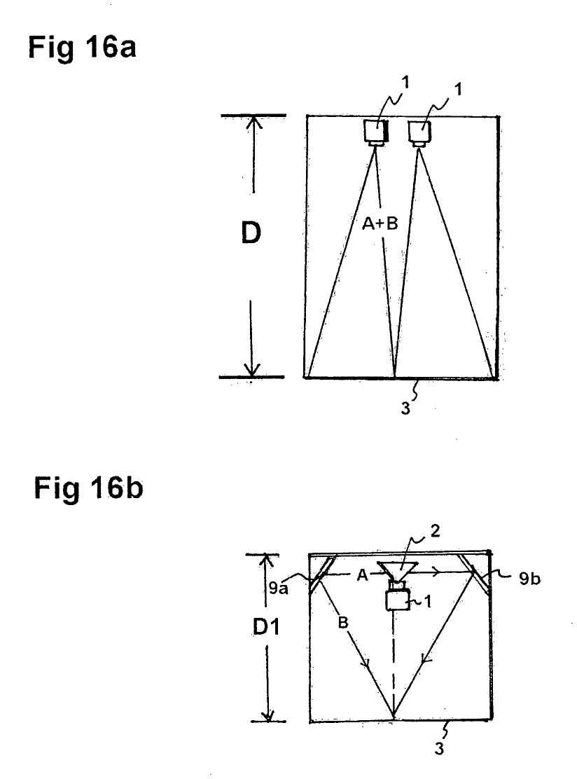

As shown in FIG. 16a, the conventional solid image projection system, as described above, has a big volume due to the projection distance A+B of the projectors and a heavy weight caused by two projectors, and requires a synchronizing device for synchronizing the two separated images.

However, since the dual image projection system of the present invention in FIG. 16b has a structure for separating a single image into left and right images using the separation mirror 2, the volume and the weight thereof are reduced by more than a half in comparison to those of the conventional solid image projection system in FIG. 16a, and is very convenient to install and use.

Moreover, like the dual image projection system according to the sixth preferred embodiment of the present invention, a single image of the single projector 1 is separated into two images and the separated images are reflected and combined with each other on the single screen, so that a solid image projection system normally achieved by two projectors can be implemented by a single projector.

Further, since the dual image projection systems according to the preferred embodiments of the present invention are based on the dual image projection system depicted in FIG. 2 and are structured such that a single image from a single projector 1 is separated into two images using an image editor, the two image are completely separated by the separation mirror 2 to reflect the same image in different directions onto left and right screens 3a and 3b (or the front and rear screens), so that the left and right images are displayed as normal images on the screen whereby a viewer can watch the displayed images as the normal images.

Thus, according to the dual image projection system of the present invention, the big volume due to plural projectors is remarkably reduced by using a single projector. Moreover, the single projector can project plural images, more than two images, on the left and right screens or the front and rear screens so that a wide image can be displayed. As such, the images displayed on the left and right screens or the front and rear screens are normal images without distortion, and the weight of the dual image projection system is remarkably reduced so that the dual image projection system can be utilized for various image systems. Accordingly the dual image projection system, prevents the complexity of a cooling device for removing heat generated from light sources as the number of the projectors is increased, reduces costs resulting from an increased number of projectors, and therefore significantly reduces the costs necessary for exchanging lamps of the projectors as consumable items.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A dual image projection system comprising:
a separation mirror disposed in front of a projection lens of a single projector, onto which an edited image is inputted, on a central axis of the projection lens to separate the edited image into a left image and a right image or a upper image and a lower image;
wherein the separation mirror includes a left reflection surface and a right reflection surface respectively formed on a left slope and a right slope of the separation mirror to separate a single image of the projector into the left image and the right image or forward image and backward image and to project the left image and the right image on a left screen and a right screen or a front screen and a rear screen respectively disposed at the left side and the right side or at the front side and the rear side of the single projector, and the images formed on the left screen and the right screen are normal images whose left and right sides are not reversed.

2. The dual image projection system as set forth in claim 1, wherein the left and right screens are formed on a left slope and a right slope of a triangular frame, and the single projector and the separation mirror are installed inside the triangular frame.

3. The dual image projection system as set forth in claim 2, wherein the left and right screens formed on the triangular frame are coupled with a desk such that two more persons who are respectively in front of and behind the desk can watch the images displayed on the screens simultaneously.

4. The dual image projection system as set forth in claim 1, wherein the single image of the single projector is separated into the left and right images by the separation mirror, completely separated and reflected by a left reflection mirror and a right reflection mirror which are disposed at the left side and the right side of the separation mirror such that the images are formed on the left and right screens arranged horizontally in front of the single projector in series.

5. A solid dual image projection system comprising:
a separation mirror for separating a single image of a single projector into two images; and
a left polarization plate and a right polarization plate for deflecting the separated images to combine the separated images on a screen.
